(19) United States
(12) Patent Application Publication
(10) Pub. No.: US 2007/0198939 A1
(43) Pub. Date: Aug. 23, 2007

(54) SYSTEM AND METHOD FOR THE PRODUCTION OF PRESENTATION CONTENT DEPICTING A REAL WORLD EVENT

(76) Inventor: Josh Todd Gold, Newport Coast, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/676,922

(22) Filed: Feb. 20, 2007

Related U.S. Application Data
(60) Provisional application No. 60/766,948, filed on Feb. 21, 2006.

(51) Int. Cl. G09G 5/00

(52) U.S. Cl. 715/757; 345/679

(57) ABSTRACT

The present invention provides a system and method for the production of presentation content depicting a real world event on one or more presentation devices, comprising an event content producer for producing event content for the real world event, an event content distributor for distributing the event content from the event content producer, and an event content translator for receiving event content from the event content distributor and translating the event content to presentation content by generating renderings of the simulation for display on the one or more presentation devices.

### REFERENCE TO RELATED APPLICATIONS

This application claims priority to U.S. Provisional Patent Application No. 60/766,948 filed Feb. 20, 2006, the content of which is incorporated herein by reference in

### FIELD OF THE INVENTION

The invention broadly relates to a system and method for the production of presentation content depicting a real world event on one or more presentation devices utilizing 3D rendering systems in a manner configurable by end users.

### BACKGROUND OF THE INVENTION

Real world events have had an increasingly large economic, social, and cultural impact on worldwide audiences. Increases in average athlete salaries across the spectrum of professional sports have continued to outpace standard increases in inflation and cost of living adjustments. Ticket pricing and sales for live real world events continue to reward team and venue owners handsomely. In addition, cable, satellite, broadcast, and pay-per-view broadcasts of marquee real world events garner large percentages of TV viewership and advertising revenue when compared to other types of content designated for broadcast.

As a consequence of the popularity of real world event broadcasts, there is a large secondary market for broadcast enhancement technologies. This class of technologies includes a wide variety of telemetry gathering devices and display mechanisms, from ball speed and location sensing in golfing events to vehicle progress tracking and dashboard statistic monitoring in car racing events. In addition to statistic, progress, and objective tracking technologies, broadcast enhancements also include real time broadcast overlay technologies like those used to highlight pucks in hockey broadcasts and required first down yardage in American football game broadcasts.

Broadcast enhancement technologies in common use also include various announcer analysis technologies for real world events. These include hand drawn or computer generated diagrams, sketches, and analysis inserted in place of the broadcast video stream as well as hand drawn or computer generated notes, tags, or figures inserted as an overlay on top of the broadcast video stream. These technologies are intended to improve the broadcast viewer experience by exposing the viewer to detailed information provided on the fly by subject matter experts.

The popularity of real world events has been accompanied by an increase in the popularity of video games based on specific types of real world events, which provide consistently impressive revenues for developers and publishers. Within the group of video games based on real world events, titles are frequently differentiated by the degree to which they utilize real data from the real world events on which they are based. Popular basketball titles license player data like name, height, weight, and occasionally performance history from the NBA or the NCAA, while popular car racing titles license car model, performance data, and track geometry from car manufacturers and racing venues. The accuracy of the real world data employed generally correlates well with the popularity of various real world event based video games.

There are several conventional ways for observers to experience a real world event including viewing the event in person, viewing the event via a broadcast medium, and experiencing the event by playing an appropriately chosen video game. In some cases, observers will experience an event in person while viewing the broadcast, or view the broadcast while playing a video game configured to resemble the actual event currently taking place. However, these conventional systems suffer from a number of drawbacks.

While live real world events provide a strong sense of place and immediacy, they do not provide a sufficiently flexible viewpoint, or sufficient data about the event competitors on demand. Broadcast events can be annotated, enhanced, edited, and analyzed, but the broadcast generated as a result of this process is shared by all potential viewers and cannot generally be adapted based on individual preferences. Video games based on types of real world events can provide accurate general data about the competitors and customizable interfaces with the action, but the action bears only a general resemblance to a specific current or historical real world real world event.

### SUMMARY OF THE INVENTION

The present invention involves the use of three-dimensional rendering systems and telemetry data obtained from real world events to create end user configurable virtual representations of the real world events. The rendering system may be implemented as machine readable instructions based in software or hardware or both, and residing on a set top box, laptop, desktop, console system, mobile phone, portable gaming device, or other computing device. In operation, telemetry data regarding the competitors is acquired from sensory devices in the real world event from automated analysis of audio and video data streams, updates generated by human operators, and/or other sources. This telemetry data is consolidated, repackaged, and sent to the rendering systems via traditional cable, satellite, or broadcast mechanisms, via a high speed data network, via a variety of wireless data transmission mechanisms, or via other data transmission mechanisms.

Upon receipt of telemetry data, the rendering system uses the data to generate a three-dimensional virtual version of the real world event described by the data and displays it to the end user in a manner chosen by the user. High level customization capabilities may be provided to the end user depending on configuration. Such high level customization capabilities may include, but are not limited to: (i) viewing broadcast audio and video, (ii) viewing broadcast video with customized data overlay, (iii) viewing broadcast video with customized data overlay as well as a customized view of virtual version of the event, and (iv) viewing the customized virtual version of the event only.

In accordance with the principles of the invention, customization may also be provided with respect to the generated virtual view of the real world event. These virtual view customization capabilities may include without limitation: (i) nearly limitless point of view (POV) selection, (ii) highlighting or ghosting of objects or objectives, (iii) POV binding to static or dynamic objects, (iv) preset triggers for specific virtual events, (v) effect binding to objects, events, or event objectives, and (vi) virtually any other customizations desired by the end user. Additional customization capabilities may be provided that allow visualization of elements and effects not normally visible through in-person or broadcast views. Such visualization capabilities may include, but are not limited to: (i) airflow visualization, (ii) simulated low light visualization, (iii) temperature and energy gradient visualizations, (iv) athlete heart rate, and (v) other alternative visualization technologies suitable for virtual viewing of the real world event in question.

In accordance with a preferred embodiment of the present invention, a system and method for the production of presentation content depicting a real world event on one or more presentation devices comprises an event content producer for producing event content for the real world event, an event content distributor for distributing the event content from the event content producer, and an event content translator for receiving event content from the event content distributor and translating the event content to presentation content by generating renderings of the simulation for display on the one or more presentation devices.

According to the invention, the real world event may be selected from the group consisting of a motor sports event, a military training exercise, a policing force training exercise, a portion of the operations of one or more commercial or industrial enterprises, an artistic performance, a theater performance, and a music concert. In addition, the presentation content may be provided for an entertainment presentation, wherein the presentation content depicts a dramatic version of the real world event.

In the preferred implementation of the invention, the event content producer comprises a telemetry reception means for receiving telemetry measurements of one or more real world objects of the real world event, and one or more algorithms for converting the telemetry measurements of each real world object to corresponding telemetry based virtual world values. Additionally, the event content distributor comprises an event content transmitter for receiving event content from the event content producer and transmitting the received event content for reception by one or more event content receptors. Each event content receptor receives event content from the event content transmitter and sends the received event content to the event content translator. The event content receptors may be disposed at a location local to the presentation devices, and the presentation devices may be disposed at a location remote from the event content transmitter.

According to the preferred system and method, the event content translator comprises a human interface for a presentation content user to select one or more user specified depiction determination selections. Specifically, the event content translator comprises (i) means for receiving transmissions from one or more human interface devices, (ii) one or more algorithms for the interpretation and implementation of the one or more user specified depiction determination selections, (iii) simulation algorithms for generating a simulation of the real world event, wherein each telemetry based virtual world value from the event content is used as the corresponding telemetry based virtual world value of the simulation, (iv) rendering algorithms for generating renderings of the simulation for one or more of the presentation devices, wherein the renderings are generated synchronous with the simulation, and (v) means for composing the presentation content from the renderings.

The one or more user specified depiction determination selections may comprise user control of a temporal position of the simulation, a temporal direction of the simulation, and a temporal rate of the simulation. Additionally, each presentation device may comprise a display device and a sound output device, wherein the one or more user specified depiction determination selections include user control of the virtual cinematography of the renderings generated for the display device. User control of the virtual cinematography may include (i) the ability to select a target from a plurality of targets within the simulation that the renderings track, wherein the plurality of targets include one or more virtual world objects, (ii) control of the position within the simulation that the renderings are taken from, (iii) control of the direction within the simulation that the renderings are taken from, and (iv) the ability to select a camera style from a plurality of camera styles to use for the renderings, wherein the camera style comprises an algorithmic determination of position and direction within the simulation that the renderings are taken from.

According to the invention, the event content producer produces event content including telemetry based virtual world values that are concurrent with the real world event and at a rate equal to a rate at which the telemetry measurements are made. The event content distributor distributes the telemetry based virtual world values concurrent with the production of the telemetry based virtual world values and at a rate equal to the rate at which the telemetry measurements are made. In addition, the event content distributor distributes the telemetry based virtual world values (i) concurrent with the translation of the event content to the presentation content and (ii) before any of the telemetry based virtual world values are used for the simulation. The event content translator translates the event content to the presentation content concurrent with the real world event, wherein the event content translator simulates the real world event to operate at the same rate as the real world event. The event content transmitter may transmit the event content by way of the Internet for reception by the event content receptors. Alternatively, the event content transmitter may transmit the event content by way of a cellular network, or a removable recording medium for a data storage device, wherein the data storage device comprises an optical storage device, and the recording medium comprises a CD or a DVD.

According to some embodiments, the system and method may further comprise a measurable quality measurement tool and a clock time measurement tool. Particularly, the measurable quality measurement tool is employed to obtain a first virtual measurement of a virtual world measurable quality of one or more virtual world objects over a virtual world clock time of the real world event. Additionally, the measurable quality measurement tool includes one or more algorithms for translating the first virtual measurement to a measurement value corresponding to an equivalent measurement of the corresponding measurable quality of the one or more real world objects over the virtual world clock time span of the real world event. The first virtual measurement may comprise a measurement of distance, a measurement of direction, a measurement of velocity, or a measurement of acceleration.

The clock time measurement tool is used to obtain a second virtual measurement of a virtual world clock time. Specifically, the clock time measurement tool includes one or more algorithms for translating the second virtual measurement to a measurement value corresponding to an equivalent measurement of the corresponding virtual world clock time span of the real world event. The second virtual measurement may comprises a measurement of a clock time, a span of clock time, and a duration of time.

According to a further embodiment of the invention, a system for the production of presentation content for one or more presentation devices, wherein the presentation content depicts a real world event, comprises an event content production mechanism for the production of event content for the real world event, an event content distribution mechanism for the distribution of the event content from the event content production mechanism, and an event content translation mechanism for receiving the event content from the event content distribution mechanism, translating the event content to presentation content, and transmitting the presentation content to the one or more presentation devices.

The event content production mechanism includes a telemetry reception mechanism for receiving the set of telemetry measurements of each real world object of the real world event. Additionally, the event content production mechanism includes a first computational mechanism for operating one or more algorithms to convert the set of telemetry measurements of each real world object of the real world event to a corresponding set of telemetry based virtual world values. The event content distribution mechanism includes an event content transmission mechanism for receiving the event content from the event content production mechanism and transmitting the received event content to a plurality of event content reception mechanisms. Each event content reception mechanism receives the event content from the event content transmission mechanism and sends the received event content to the event content translation mechanism. The event content reception mechanisms may be disposed at a location local to the presentation devices, and the presentation devices may be disposed at a location remote from the event content transmitter.

The event content translation mechanism also includes a human interface for a presentation content user to select one or more user specified depiction determination selections. The user specified depiction determination selections may comprise (i) one or more human interface devices, (ii) a communication mechanism for receiving transmissions from the human interface devices, (iii) a second computational mechanism for operating algorithms interpreting and implementing the one or more user specified depiction determination selections, for operating simulation algorithms calculating the simulation of the real world event using each telemetry based virtual world value from the event content for the corresponding telemetry based virtual world value of the simulation, and for operating rendering algorithms calculating renderings of the simulation synchronous with the simulation for the one or more of the presentation devices, and for composing the presentation content from the renderings, and (iv) a presentation content transmission mechanism for transmitting the presentation content to the one or more presentation devices. The second computational mechanism may comprise a personal computer, a video game console, or a cellular telephone.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein may illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

Features, aspects, and embodiments of the inventions are described in conjunction with the attached drawings, in which:

FIG. 1 is a schematic drawing illustrating system architecture elements and their relationship in accordance with a system for creating 3D virtual representations of real world events utilizing real event telemetry;

FIGS. 2A and 2B are schematic drawings illustrating the functionality and relationship between various sub-components of the sensor and processing module component of the system of FIG. 1;

FIG. 3 is a schematic drawing illustrating the functionality and relationship between various modules of the central control and server module component of the system of FIG. 1;

FIG. 4 is a schematic drawing illustrating the functionality and relationship between various sub-components of the system client component of the system of FIG. 1; and

FIG. 5 is a schematic drawing illustrating the flow of telemetry based information from a real world event to the depiction of the real world event.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

Before starting a description of the Figures, some terms will now be defined.

Event content: Data representing a real world event. Event content may include (i) a set of telemetry-based virtual world values for each real world object from the real world event, and (ii) a set of models for virtual world objects of telemetry-based virtual world values for use in rendering the corresponding real world objects.

Event depiction: A representation of a real world event from the event content for the real world event.

Human interface device: A device which interacts directly with a human user to take input from the user and enable the input to be transmitted to a computer. Examples include a mouse, a keyboard, and a joystick. Exemplary uses include enabling the user to input data, indicate intentions, convey interest, or specify a selection.

Presentation device: A device that produces sensory output detectable by at least one sense. A presentation device may be connected to one or more sources of content for the device by way of a communication means, such that the device selectively produces a sensory output depending on the chosen content. Examples include televisions, monitors, stereos and surround sound systems.

Presentation content: Content in an encoding suitable for input to one or more presentation devices.

Rendering: A process of converting an aspect of a simulation into a form compatible with a presentation device of a selected type and capabilities. Exemplary rendering operations include (i) the conversion of a view from a selected position in a selected direction within a simulation to a form suitable for transmission to a presentation device, and (ii) the conversion of a soundscape from a selected position in a selected direction within a simulation to a form suitable for transmission to a sound output device.

Real world event: A real world clock time span and a set of one or more real world objects. For each real world object, there exists a set of telemetry measurements, where the real world clock time span for each telemetry measurement is within the real world clock time span of the real world event. Examples include (i) a motor sports event, wherein the position of the participating vehicles are measured at regular intervals during the duration of the event, and (ii) a sail boat race, wherein the position, hull speed, air speed, direction of the participating boats, water current speed and direction at a set of fixed locations, and air speed and direction at a set of fixed locations, are measured at predetermined intervals during the event.

Real world clock time span: A span of clock time bound by a start clock time and an end clock time, wherein the span is formed from a measurement of real world time, a duration of real world time, and an offset of real world time. The start clock time is equal to the sum of the measurement and the offset, and the end clock time is equal to the sum of the measurement, the offset, and the duration. The offset and duration may be either implicit or explicitly measured, and the start clock time and end clock time may implicitly, explicitly, or effectively share a common time scale. Examples of real world clock time spans include (i) 5/16/2006 1:45 PM to 5/16/2006 3:00 PM local time, and (ii) 5/16/2006 05:47:32.843 UTC, with an implicit error range of plus or minus 4 milliseconds. Examples of time scales include (i) Greenwich Mean Time, (ii) Coordinated Universal Time, (iii) the local time scale of some time zone, and (iv) any time scale based on one or more clocks.

Real world object: A physical object in the real world. Examples include solids, liquids, and gas bodies, or some collection of the bodies, such as a car, a person, a surface of an area of land, a road, a body of water, and a volume of air.

Real world measurable quality: A measurable quality of a real world object. Examples include size, mass, location, direction, velocity, acceleration, pressure, temperature, electric field, magnetic field, and other physical properties of a real world object.

Real world measurement: A value of a measurement (or a composite of measurements) of a real world quality of a real world object over a real world clock time span. The value of the composite measurement and the corresponding real world clock time span of the composite measurement may be calculated using interpolation, extrapolation, curve fitting, averaging, or some other algorithm, from the plurality of measurements. Examples include (i) the measurement of the location of a particular vehicle at a particular time, (ii) a plurality of measurements of the location of the vehicle over a time span, and (iii) interpolating between the measurements using the time span to calculate the vehicle position at a particular time within the time span. Exemplary uses of composite measurements include (i) obtaining a likely measurement at a time when no measurement was actually made, such as at a time between two measurements, (ii) increasing the accuracy of a measurement by averaging a plurality of measurements, and (iii) increasing or decreasing the rate of measurements to a desired rate (e.g., the measurement of the position of an object may be reduced from a rate of 75 times per second to a rate of 60 times per second).

Simulation: A virtual three dimensional reality generated by algorithms operating on one or more computational devices. A common example of a simulation is a video game, wherein a virtual world is generated by a computer.

Telemetry measurement: A real world measurement made using telemetry. Examples include (i) the measurement of a three dimensional position of a vehicle by a GPS device, and (ii) the measurement of the engine speed of the vehicle by an engine speed sensing device. Such measurements may be saved locally for later retrieval or sent wirelessly to a remote telemetry receiver.

Telemetry based virtual world value: The virtual world value of a virtual world quality of a virtual world object over a virtual world clock time span. The virtual world value reflects a telemetry measurement, and the virtual world measurable quality corresponds to the real world quality of the telemetry measurement. In addition, the virtual world object corresponds to the real world object of the telemetry measurement, and the virtual world clock time span corresponds to the real world clock time span of the telemetry measurement.

User specified depiction determination selection: A user specified selection which determines one or more aspects of a depiction. Such selections typically do not alter telemetry based virtual world values. Examples include (i) selecting the order, speed, or direction in which some portion of the event is simulated, such as show highlights only, slow motion, or reverse time playback, and (ii) selecting the position and direction from which some portion of the event is rendered from, such as positioning the virtual camera capturing the visual depiction, selecting the model to use for an object when rendering that object, selecting lighting to use when rendering, and selecting the character of the accompanying musical score or narration.

Virtual world clock time span: A span of virtual clock time, bound by a start virtual clock time and an end virtual clock time, within a virtual three dimensional reality of a simulation. One example is a representation within a simulation of a real world clock time span.

Virtual world object: A virtual physical object within the virtual three dimensional reality of a simulation. Examples include representations within a simulation of a real world object, such as a race track, a vehicle, a body of water, a building or other structure, surface features of an area of land, and a volume of air.

Virtual world measurable quality: A virtual measurable quality of a virtual world object. One example is a representation within a simulation of a real world measurable quality.

The present invention is directed toward systems and methods for generating a three-dimensional (3D) virtual version of a real world event utilizing a 3D rendering system, telemetry data collected by various means from a real world event, and user generated configuration data. The invention may employ various technologies, including without limitation: (1) real time rendering, sound, physics models and algorithms (e.g. game engines); (2) common consumer use of efficient graphics hardware (e.g. 3D video cards); (3) efficient network protocols and networks for data transmission; and/or (4) a wide variety of efficient sensors and other technologies in current use for gathering telemetry data (e.g. differential GPS, LiDAR, accelerometers, camera arrays).

The present invention may be implemented using the components and functional architecture described hereinbelow. For illustrative purposes, the system is restricted to a specific type of real world event, in this case a motor sport race. As would be appreciated by those of ordinary skill in the art, the system described herein may be modified to generate a 3D virtual version of other real world events such as football, baseball, basketball, soccer, track and field, hockey, tennis, golf, skiing, and any other real world event, without departing from the scope of the invention. By way of example, the real world event may comprise a military training exercise, a policing force training exercise, a portion of the operations of one or more commercial or industrial enterprises, an artistic performance, a theater performance, or a music concert.

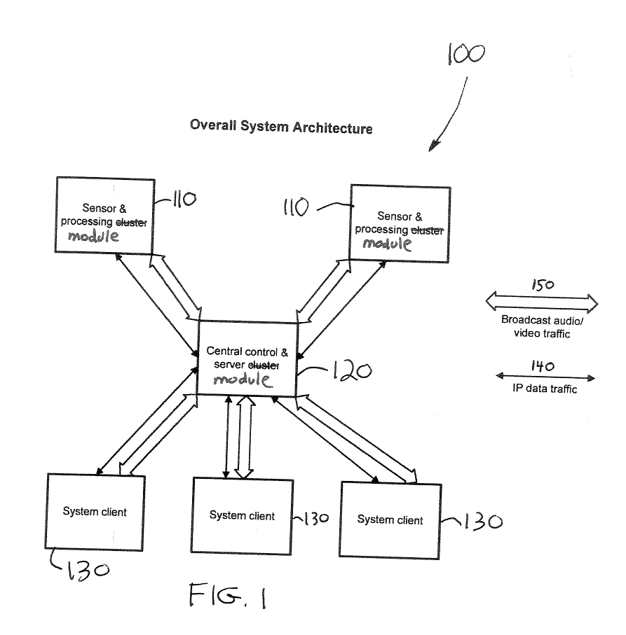

Referring to FIG. 1, a system 100 for creating 3D virtual representations of real world events utilizing telemetry obtained from a real world event will now be described. Specifically, the system 100 comprises one or more sensor and processing modules 110, one or more central control and server modules 120, one or more system clients 130, and a mechanism for data transmission 140, 150 that provides connections between these components. The sensor and processing modules 110 may be connected to the central control and server module 120 via a data transmission mechanism 140 (such as a high speed data transmission network) and/or standard broadcast mechanisms 150 (such as traditional audio and visual data broadcast mechanisms). Additionally, the system clients 130 may be connected to the central control and server module 120 by similar data transmission mechanism 140 and/or broadcast mechanisms 150. All data transfer channels in the system 100 may be bidirectional. The scope and relationship of specific functionality within the components may change depending on the implementation choices made by a practitioner of ordinary skill in the art.

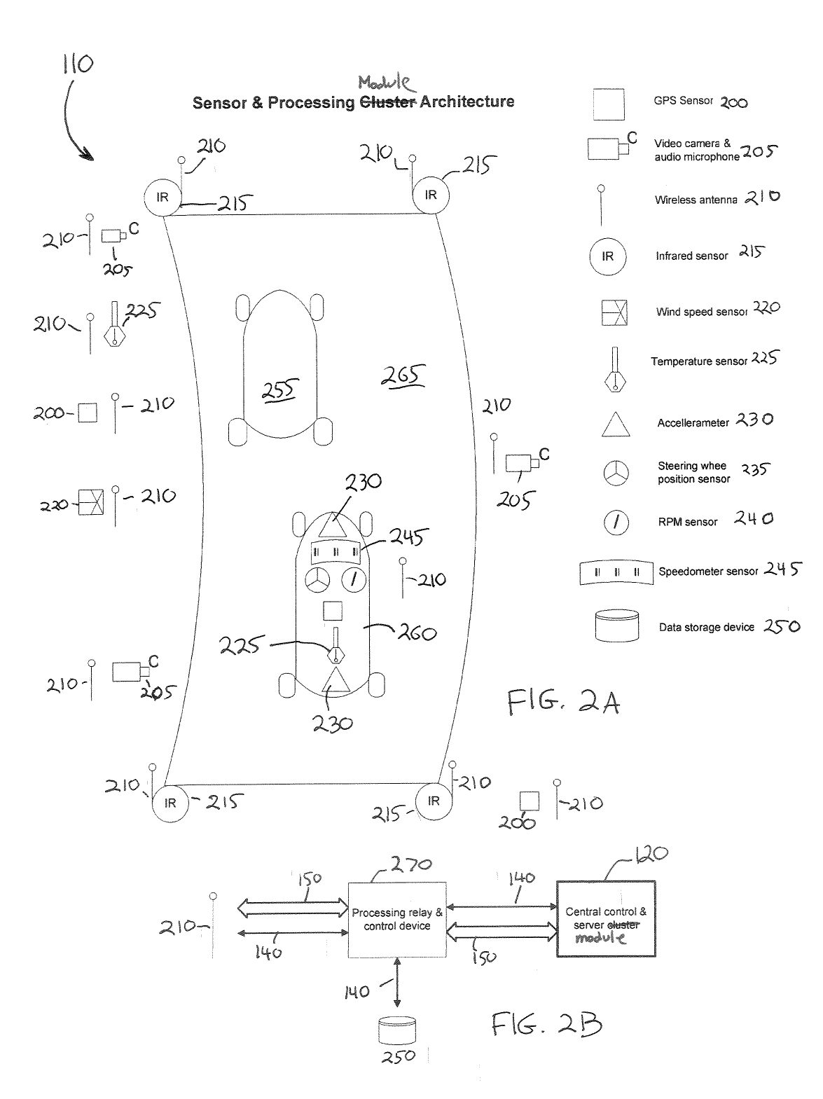

From an information flow perspective, the initial component of the present invention is the sensor and processing module 110, which is employed to make telemetry measurements with respect to the real world event. The structure of and relationship between the subcomponents in the sensor and processing module 110 is illustrated in FIG. 2 and described in the following paragraphs. Particularly, each sensor and processing module 110 comprises (i) a network or networks of static and/or dynamic sensors 200-245 to collect data by way of telemetry measurements, (ii) one or more processing, relay, and control devices 270, and (iii) a mechanism for data transmission 140, 150 that provides connections between the sub-components.

Referring to FIG. 2A, the functionality and relationship between the various sub-components of the sensor and processing module component 110 of the system 100 for creating 3D virtual representations of a real world event utilizing telemetry obtained from the real world event will now be described. In particular, the sensor and processing module 110 comprises a number of static and dynamic sensors including global positioning system (GPS) sensor 200, a video camera and audio microphone 205, wireless antennae 210, an infrared sensor 215, a wind speed sensor 220, a temperature sensor 225, an accelerometer 230, a steering wheel position sensor 235, an RPM sensor 240, and a speedometer sensor 245. The sensor and processing module 110 may further comprise one or more data storage devices 250. For purposes of illustration, the real world event comprises a motor sport event, wherein the static and dynamic sensors 200-245 are installed on one or more motor sport vehicles 255, 260 (i.e., real world objects) in order to monitor the vehicles 255, 260 during a racing event on and around a motor sport track 265.

Referring to FIG. 2B, the sensor and processing module 110 also comprises one or more processing, relay and control devices 270, which are connected via a high speed data transmission network 140 and/or conventional audio and visual data broadcast mechanisms 150 to the central control and server module 120. In addition, all static and dynamic sensors 200-245 are connected via wireless data transmission mechanisms 210 to the one or more processing, relay and control devices 270 and communicate via data transmission mechanisms 140, 150. It should be clear to a practitioner of ordinary skill in the art that the specific sensors chosen are illustrative in nature, and should in no way restrict the scope of the present invention with respect to the selection of alternative or additional information gathering mechanisms.

According to the invention, the network of static sensors may comprise one or more sensors for making telemetry measurements of event content. The sensors are installed on or around the motor sport track 265, including without limitation: (i) one or more video cameras and audio microphones, (ii) one or more differential GPS base stations, (iii) one or more infrared beam based movement sensors, (iv) one or more wind speed sensors, and/or (v) one or more temperature sensors. The network of dynamic sensors may comprise one or more sensors installed on or around each motor sport vehicle 255, 260 participating in the motor sport race, including without limitation: (i) one or more video cameras and audio microphones, (ii) one or more accelerometers, (iii) one or more GPS receivers, (iv) an RPM sensor, (v) a steering wheel position sensor, (vi) one or more temperature sensors, (vii) a speedometer sensor, and/or (viii) one or more other systems for collecting strain and input data from the vehicle.

Event content collected by the network of static and dynamic sensors 200-245 is sent via wireless data transmission to a wireless receiver. After reception, incoming data is processed by analog and/or digital devices using programmatic or manual means, thereby generating various streams of audio, video, and packet data. These information streams are then retransmitted to the central control and server module 120 via one or more of the data transmission mechanisms 140, 150.

In accordance with the principles of the invention, the network of static and dynamic sensors 200-245 can also be configured and/or controlled remotely. For example, sensor control signals may be generated (i) by system clients 130 via the central control and server module 120, (ii) by the central control and server module 120 directly, or (iii) by the processing, relay and control device 270 of the sensor and processing module 110. The network of static and dynamic sensors 200-245 may be configured and controlled individually, or sets of one or more sensors can be controlled in unison. All sensor control signals are processed by the processing, relay and control device 270 and then sent via wireless data transmission to the wireless receivers 210 associated with individual sensors or groups of sensors.

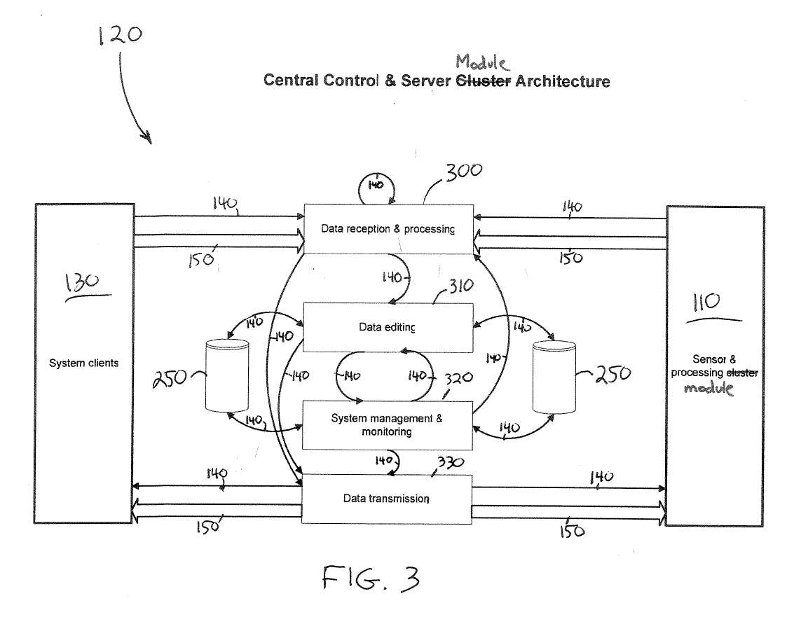

From an information flow perspective, the second component of the system 100 comprises the central control and server module 120. The general structure of and relationship between the sub-components of the central control and server module 120 is illustrated in FIG. 3 and described in the following paragraphs. According to the invention, the central control and server module 120 may comprise: (i) a data reception and processing module 300, (ii) a data editing module 310, (iii) a system management and monitoring module 320, and (iv) a data transmission module 330.

Referring to FIG. 3, the functionality and relationship between the various sub-components of the central control and server component 120 of the system 100 for creating 3D virtual representations of a real world events utilizing telemetry obtained from the real world event will now be described. Particularly, incoming information from one or more system clients 130 and incoming event content from one or more sensor and processing modules 110 are received via a high speed data transmission network 140 and/or conventional audio and visual data broadcast mechanisms 150. The incoming data containing event content is then processed by a data reception and processing module 300, which receives processing instructions based on configuration data from a system management and monitoring module 320. Based on the configuration data, the system management and monitoring module 320 either (i) passes the data to a data transmission module 330 for retransmission to one or more system clients 130 or one or more sensor and processing modules 110, (ii) performs further processing on incoming data, and/or (iii) passes incoming data to a data editing module 310.

The data editing module 310 performs editing tasks on the data as instructed by programmatic or user interaction, and passes incoming data to the data transmission module 330 for retransmission while maintaining a bidirectional status and control interface with the system management and monitoring module 320. The system management and monitoring module 320 maintains status information for all modules within the central control and server module 120 as well as all elements of any connected system clients 130 and sensor and processing modules 110. The data editing module 310 stores configuration, logging, and other system information within the one or more data storage devices 250 and, when requested, passes identified data to the data transmission module 330 for retransmission to one or more system clients 130 or one or more sensor and processing modules 110.

As set forth hereinabove, the data reception and processing module 300 receives information from one or more system clients 130 and/or one or more sensor and processing modules 110. In operation, the data is processed according to configuration data stored by the system management and monitoring module 320, and is then passed directly to the data transmission module 330 for transmission to (i) one or more system clients, (ii) one or more sensor and processing modules, or (iii) a combination thereof. Alternatively, the data may be passed to the data editing module 310 for additional programmatic or manual manipulation. Some or all of the information passed through the data reception and processing module 300 is additionally stored on various data storage devices 250 based on configuration information from the system management and monitoring module 320. Such information may be stored in raw database formats, archival formats or broadcast formats for later utilization. Suitable data storage devices 250 include, but are not limited to, archival tape storage devices, hard disk drive devices, flash memory devices, random access memory (RAM) devices, and other data storage devices.

With further reference to FIG. 3, the data editing module 310 receives data directly from the data reception and processing module 300 and/or from information stored on data storage devices 250. Incoming data is modified programmatically according to configuration data stored by the system management and monitoring module 320 and/or according to editing choices within the data editing module 310. These editing choices may be chosen by human operators logged in via the system management and monitoring module 320, either locally or remotely. Potential modifications to received data include without limitation: (i) fixing errors in telemetry data, (ii) smoothing telemetry data, (iii) editing redundant or misleading telemetry data, (iv) entering additional telemetry data, (v) otherwise adding, deleting, or modifying telemetry data, and (vi) adding, deleting or modifying audio or visual broadcast data streams in an arbitrary manner. After the data is modified using the data editing module 310, the information is passed directly to the data transmission module 330 for broadcasting to the system clients 130 and/or sensor and processing modules 110, and for storage on one or more data storage devices 250.

According to the invention, the system management and monitoring module 320 capabilities including, but not limited to: (1) client creation and management functions; (2) community creation and management functions; (3) administrator creation and management functions; (4) sensor processing and management functions; (5) data reception, transmission processing and management functions; (6) data archival processing and management functions; and (7) system wide management and monitoring functions.

As set forth hereinabove, the data transmission module 330 may receive information for transmission from (i) the data reception and processing module 300, the data editing module 310, and/or from various data storage devices 250 via the system management and monitoring module 320. The information is processed for transmission and then transmitted via one or more data transmission mechanisms 140, 150 to one or more system clients 130 and/or one or more sensor and processing modules 110.

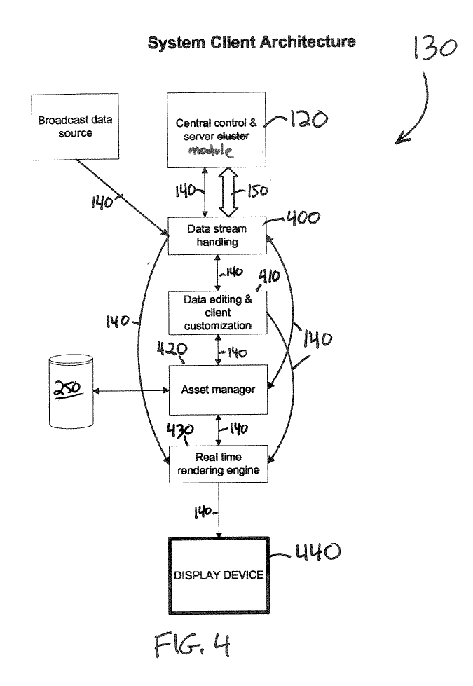

From an information flow perspective, the third component of the system 100 comprises the system clients 130. The general structure of and relationship between the sub-components of each system client is illustrated in FIG. 4 and described in the following paragraphs. According to the invention, a system client 130 may comprise: (i) a data stream handling component, (ii) a data editing and client customization component, (iii) an asset manager, and (iv) a real time rendering engine.

Referring to FIG. 4, the functionality and relationship between the various sub-components of the system client component 130 of the system for creating 3D virtual representations of real world events utilizing real event telemetry will now be described. Specifically, a data stream handling component 400 of the system client 130 receives information via one or more data transmission mechanisms 140, 150 from the central control and server module 120. Additionally, the data stream handling component 400 of the system client 130 may receive information from a broadcast data source 405 via a high speed data transmission network 140, or internally from a data editing and customization component 410 or an asset manager component 420.

In the embodiment illustrated in FIG. 4, incoming data is processed based on configuration data requested from the data editing and customization component 410 and stored in the asset manager 420. This information is then retransmitted to the central control and server module 120, or to the data editing and customization component 410 for further programmatic or manual processing. In addition, the data may be transmitted to a real time rendering engine component 430 for display on a display device 440. The asset manager component 420 is used to perform data storage and management tasks required by the client via a data linkage 140 with one or more data storage devices 250. In operation, the real time rendering engine component 430 (i) receives information from the data stream handling component 400, (ii) receives information from the data editing and customization component 410, (iii) receives information from the asset manager component 420, and (iv) uses this data to render 3D graphics for output to the display device 440.

With continued reference to FIG. 4, the data stream handling component 400 of the system client 130 is configured to manage data reception, processing, and transmission functions. In particular, this component handles all communication with the central control and server module 120, including without limitation: (i) incoming sensor based telemetry data, (ii) outgoing sensor control telemetry data, (iii) incoming audio and video broadcast streams, (iv) outgoing content streams such as custom cut and audio/video data, (v) client updates and other interactions with the system management and monitoring module 320 of the central control and server module 120, and (vi) rendering engine sourced outgoing content requests passed along from the asset manager component 420 or incoming assets from the central control and server module 120. The data stream handling component 400 also handles any broadcast data received from data sources external to the system. During client playback, data streams are processed according to preferences held within and/or by real time user manipulation of the data editing and client customization component 410, and are then displayed via the real time rendering engine component 430 on display device 440.

In accordance with the principles of the present invention, the data editing and client customization component 410 allows the user to control how incoming data telemetry and video broadcast streams are displayed by the real time rendering engine component 430. Additionally, the data editing and client customization component 410 (i) allows the user to record preferred viewing settings, (ii) allows the user to create and record customized sets of telemetry and audio visual data that can be exported to other clients directly or via the central control and server module 120, and (iii) allows the user to choose content available from the central control and server module 120 to view or download for later use.

Various high level display configuration options are available to the end user through the data editing and client customization component 410 utilizing the real time rendering engine component 420. Such display configuration options include, but are not limited to: (1) viewing broadcast audio and video of the real world event alone; (2) viewing broadcast video of the real world event with a customized data overlay generated from sensor data telemetry streams; (3) viewing broadcast video of the real world event with a customized data overlay as well as a customized view of a fully simulated version of the real world event; and (4) viewing the customized virtual version of the real world event alone.

According to the invention, various customizable viewing options are also available to the end user within the simulated version of the real world event. These customizable viewing options may include without limitation: (1) nearly unlimited POV selection; (2) highlighting or ghosting of objects or objectives within the real world event; (3) POV binding to static or dynamic objects within the event; (4) preset triggers for specific events tied to sensor telemetry streams; (5) visual effect binding to objects, events, or event objectives; and (6) virtually any other customizable viewing options desired by the end user. Additional customization features may include those that allow visualization of elements and effects not normally visible through in-person or traditional broadcast views of the real world event, including but not limited to, (i) airflow visualization, (ii) simulated low light visualization, and (iii) temperature, energy gradient, and other varied energy spectrum visualizations based on sensor data.

With further reference to FIG. 4, the asset manager 420 manages a client side data store of all information required by the real time rendering engine component 430 to successfully render 3D simulated versions of the real world event from available sensor telemetry streams. Various assets managed by the asset manager 420 may include, but are not limited to: (1) 3D polygon meshes of all the objects in the simulation; (2) textures required to skin the polygon meshes; (3) texture bump maps; (4) geometry displacement maps; (5) light source data; (6) shader information; (7) physics data; (8) synthesized sound information; (9) all current, stored, or edited telemetry streams; (10) all client configuration or editing data; and (11) any predefined animations required.

According to the invention, the real time rendering engine 430 utilizes data provided by the data stream handling component 400, the asset manager component 420, and configuration data from the data editing and client customization component 410 to render and display a virtual 3D version of the real world event. Additionally, a customized game engine may be employed that provides (i) a rendering, (ii) a customizable rendering pipeline with the ability to specify techniques and data on a per-object basis, (iii) a customizable pipeline directly integrated with art tools, (iii) pixel and vertex shaders, (iv) dynamic lighting, (v) a wide range of customizable texture effects, (vi) rendered textures, and (vii) 3D surround sound effects. The real time rendering engine 430 may also provide object motion and animation effects such as (i) hierarchical, spline-based interpolations, (ii) translation and rotation key frames using linear, Bezier and TCB interpolations, (iii) quaternion based rotations, (iv) cycle control for clamping, (v) looping and reversing sequences, (vi) support for vertex morphing, (vii) light and material color animation, and (viii) texture coordinate animation.

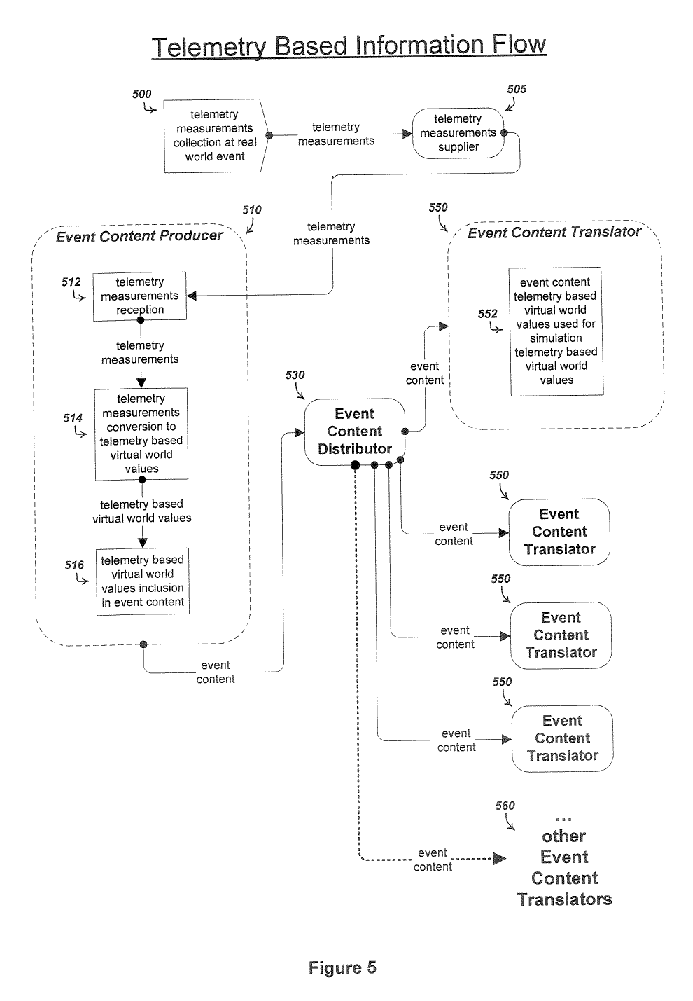

Referring to FIG. 5, the flow of telemetry based information from a real world event and the depiction of the real world event in accordance with an embodiment of the present invention will now be described. Generally, telemetry based information consists of the telemetry itself, and information based directly on that telemetry. During the real world event, telemetry measurements are collected (500), and then the collected telemetry measurements are at some time made available to a telemetry measurements supplier (505). The telemetry measurements supplier (505) preferably has the means to store the telemetry measurements and supply them to a telemetry measurements consumer. Although the telemetry measurements collection, telemetry measurements supplier, and telemetry measurements consumer are described as separate elements, one or more of these elements may comprise the operation of a single entity without departing from the scope of the invention.

With further reference to FIG. 5, an event content producer 510 uses the telemetry measurements to produce event content for the real world event, Specifically, the event content producer receives the telemetry measurements 512 from the telemetry measurements supplier, and converts the telemetry measurements into a corresponding set of telemetry based virtual world values 514, which are included in event content 516. The event content 516 may include additional information produced from other operations of the event content producer 510. According to the invention, the event content 516 is supplied to an event content distributor 530 for distribution to one or more event content translators 550. Each event content translator 550 uses the event content to generate a depiction of the real world event using the present invention.

With continued reference to FIG. 5, each event content translator 550 uses the telemetry based virtual world values portion of the event content for the corresponding telemetry based virtual world values of the simulation 552. In the illustrated embodiment, more than one event content translator 550 is depicted, including reference to an indefinite number of additional event content translators 560, to illustrate the use of the event content in a plurality of depictions of the real world event. The plurality of depictions may occur at a plurality of predetermined times and locations, and may operate on a plurality of different hardware systems. Each depiction may be presented on a different configuration of presentation devices, and each depiction may present the real world event in a different way. However, all of the depictions preferably reflect the aspects of the real world event measured in the telemetry measurements using the same telemetry based virtual world values, and these telemetry based virtual world values reflect the corresponding telemetry measurements they are based on.

In accordance with the principles of the invention, a preferred system and method for the production of presentation content depicting a real world event on one or more presentation devices will now be described. Particularly, the system includes (i) an event content producer for producing event content for the real world event; (ii) an event content distributor for distributing the event content from the event content producer; and (iii) an event content translator for receiving event content from the event content distributor and translating the event content to presentation content by generating renderings of the simulation for display on the one or more presentation devices.

According to the invention, the real world event may comprise, without limitation, a motor sports event, a military training exercise, a policing force training exercise, a portion of the operations of one or more commercial or industrial enterprises, an artistic performance, a theater performance, or a music concert. In addition, the system and method of the invention may provide presentation content for an entertainment presentation, wherein the presentation content depicts a dramatic version of the real world event.

The event content producer comprises a telemetry reception means for receiving telemetry measurements of one or more real world objects of the real world event. In addition the event content producer includes one or more algorithms for converting the telemetry measurements of each real world object to corresponding telemetry based virtual world values. The event content distributor may comprise an event content transmitter for receiving event content from the event content producer and transmitting the received event content for reception by one or more event content receptors, wherein each event content receptor receives event content from the event content transmitter and sends the received event content to the event content translator. In operation, the event content receptors may be disposed at a location local to the presentation devices, wherein the presentation devices are disposed at a location remote from the event content transmitter.

According to the preferred system and method, the event content translator includes a human interface for a presentation content user to select one or more user specified depiction determination selections, such as (i) a means for receiving transmissions from one or more human interface devices, (ii) one or more algorithms for the interpretation and implementation of the one or more user specified depiction determination selections, (iii) simulation algorithms for generating a simulation of the real world event, wherein each telemetry based virtual world value from the event content is used as the corresponding telemetry based virtual world value of the simulation, (iv) rendering algorithms for generating renderings of the simulation for one or more of the presentation devices, wherein the renderings are generated synchronous with the simulation, (v) a means for composing the presentation content from the renderings.

The one or more user specified depiction determination selections may include user control of a temporal position of the simulation, a temporal direction of the simulation, and/or a temporal rate of the simulation. The presentation devices may comprise a display device and a sound output device, wherein the one or more user specified depiction determination selections include user control of the virtual cinematography of the renderings generated for the display device. User control of the virtual cinematography may include (i) the ability to select a target from a plurality of targets within the simulation that the renderings track, wherein the plurality of targets include one or more virtual world objects; (ii) control of the position within the simulation that the renderings are taken from; (iii) control of the direction within the simulation that the renderings are taken from; and/or (iv) the ability to select a camera style from a plurality of camera styles to use for the renderings, wherein the camera style comprises an algorithmic determination of position and direction within the simulation that the renderings are taken from.

According to some embodiments of the invention, the event content producer produces event content including telemetry based virtual world values that are concurrent with the real world event and at a rate equal to a rate at which the telemetry measurements are made. In addition, the event content distributor may distribute the telemetry based virtual world values concurrent with the production of the telemetry based virtual world values and at a rate equal to the rate at which the telemetry measurements are made. The event content distributor may distribute the telemetry based virtual world values (i) concurrent with the translation of the event content to the presentation content and (ii) before any of the telemetry based virtual world values are used for the simulation. Furthermore, the event content translator may translate the event content to the presentation content concurrent with the real world event, wherein the event content translator simulates the real world event to operate at the same rate as the real world event.

In some embodiments, the event content transmitter may transmit the event content by way of the Internet for reception by the event content receptors. Alternatively, the event content transmitter may transmit the event content by way of a cellular network. As a further alternative, the event content transmitter may transmit the event content by way of a removable recording medium for a data storage device such as an optical storage device. By way of example, the recording medium may comprise a CD or a DVD.

Some embodiments of the invention may feature a measurable quality measurement tool and a clock time span measurement tool. In particular, the measurable quality measurement tool is employed to obtain a first virtual measurement of a virtual world measurable quality of one or more virtual world objects over a virtual world clock time span of the real world event. Algorithms are provided for translating the first virtual measurement to a measurement value corresponding to an equivalent measurement of the corresponding measurable quality of the one or more real world objects over the virtual world clock time span of the real world event. The first virtual measurement may comprise a measurement of distance, a measurement of direction, a measurement of velocity, and a measurement of acceleration. The clock time span measurement tool is used to obtain a second virtual measurement of a virtual world clock time span. The clock time span measurement tool comprises algorithms for translating the second virtual measurement to a measurement value corresponding to an equivalent measurement of the corresponding virtual world clock time span of the real world event. The second virtual measurement may include a measurement of a clock time, a span of clock time, and a duration of time.

In accordance with the principles of the invention, a system for the production of presentation content for one or more presentation devices, wherein the presentation content depicts a real world event, will now be described. Specifically, the system comprises (i) an event content production mechanism for the production of event content for the real world event, (ii) an event content distribution mechanism for the distribution of the event content from the event content production mechanism, and (iii) an event content translation mechanism for receiving the event content from the event content distribution mechanism, translating the event content to presentation content, and transmitting the presentation content to the one or more presentation devices.

The event content production mechanism includes a telemetry reception mechanism for receiving the set of telemetry measurements of each real world object of the real world event. In addition, the event content production mechanism includes a first computational mechanism for operating one or more algorithms to convert the set of telemetry measurements of each real world object of the real world event to corresponding set of telemetry based virtual world values.

The event content distribution mechanism includes an event content transmission mechanism for receiving the event content from the event content production mechanism and transmitting the received event content to a plurality of event content reception mechanisms. Each event content reception mechanism receives the event content from the event content transmission mechanism and sends the received event content to the event content translation mechanism. The event content reception mechanisms may be disposed at a location local to the presentation devices, wherein the presentation devices are disposed at a location remote from the event content transmitter.

The event content translation mechanism includes a human interface for a presentation content user to select one or more user specified depiction determination selections, including, but not limited to: (1) one or more human interface devices; (2) a communication mechanism for receiving transmissions from the human interface devices; (3) a second computational mechanism for operating algorithms interpreting and implementing the one or more user specified depiction determination selections, and for operating simulation algorithms calculating the simulation of the real world event using each telemetry based virtual world value from the event content for the corresponding telemetry based virtual world value of the simulation, for operating rendering algorithms calculating renderings of the simulation synchronous with the simulation for the one or more of the presentation devices, and for composing the presentation content from the renderings; and (4) a presentation content transmission mechanism for transmitting the presentation content to the one or more presentation devices. By way of example, the second computational mechanism may comprise a personal computer, a video game console, or a cellular telephone.

Thus, it is seen that a system and method for the production of presentation content depicting a real world event is provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

What is claimed is:

1. A system for the production of presentation content depicting a real world event on one or more presentation devices, comprising:
an event content producer for producing event content for the real world event;
an event content distributor for distributing the event content from the event content producer; and
an event content translator for receiving event content from the event content distributor and translating the event content to presentation content by generating renderings of the simulation for display on the one or more presentation devices.

2. The system of claim 1, wherein the real world event is selected from the group consisting of a sporting event, a motor sports event, a military training exercise, a policing force training exercise, a portion of the operations of one or more commercial or industrial enterprises, an artistic performance, a theater performance, and a music concert.

3. The system of claim 1, wherein the presentation content is provided for an entertainment presentation, wherein the presentation content depicts a dramatic version of the real world event.

4. The system of claim 1, wherein the event content producer comprises a telemetry reception means for receiving telemetry measurements of one or more real world objects of the real world event.

5. The system of claim 4, wherein the event content producer further comprises one or more algorithms for converting the telemetry measurements of each real world object to corresponding telemetry based virtual world values.

6. The system of claim 1, wherein the event content distributor comprises an event content transmitter for receiving event content from the event content producer and transmitting the received event content for reception by one or more event content receptors.

7. The system of claim 6, wherein the event content receptor receives event content from the event content transmitter and sends the received event content to the event content translator.

8. The system of claim 7, wherein the event content receptor is disposed at a location local to the presentation devices, wherein the presentation devices are disposed at a location remote from the event content transmitter.

9. The system of claim 1, wherein the event content translator comprises a human interface for a presentation content user to select one or more user specified depiction determination selections.

10. The system of claim 10, wherein the event content translator comprises:
means for receiving transmissions from one or more human interface devices;
one or more algorithms for the interpretation and implementation of the one or more user specified depiction determination selections;
simulation algorithms for generating a simulation of the real world event, wherein each telemetry based virtual world value from the event content is used as the corresponding telemetry based virtual world value of the simulation;
rendering algorithms for generating renderings of the simulation for one or more of the presentation devices, wherein the renderings are generated synchronous with the simulation; and
means for composing the presentation content from the renderings.

11. The system of claim 10, wherein the one or more user specified depiction determination selections comprise user control of a temporal position of the simulation, a temporal direction of the simulation, and a temporal rate of the simulation.

12. The system of claim 10, wherein each presentation device comprises a display device and a sound output device, wherein the one or more user specified depiction determination selections include user control of the virtual cinematography of the renderings generated for the display device.

13. The system of claim 12, wherein user control of the virtual cinematography comprises:
the ability to select a target from a plurality of targets within the simulation that the renderings track, wherein the plurality of targets include one or more virtual world objects;
control of the position within the simulation that the renderings are taken from;
control of the direction within the simulation that the renderings are taken from; and
the ability to select a camera style from a plurality of camera styles to use for the renderings, wherein the camera style comprises an algorithmic determination of position and direction within the simulation that the renderings are taken from.

14. The system of claim 1, wherein the event content producer produces the telemetry based virtual world values portion of the event content concurrent with the real world event and at a rate equal to the rate at which the telemetry measurements are made.

15. The system of claim 14, wherein the event content distributor distributes the telemetry based virtual world values concurrent with the production of the telemetry based virtual world values and at a rate equal to the rate at which the telemetry measurements are made.

16. The system of claim 14, wherein the event content distributor distributes the telemetry based virtual world values concurrent with the translation of the event content to the presentation content.

17. The system of claim 14, wherein the event content distributor distributes the telemetry based virtual world values before any of the telemetry based virtual world values are used for the simulation.

18. The system of claim 1, wherein the event content translator translates the event content to the presentation content concurrent with the real world event, wherein the event content translator simulates the real world event to operate at the same rate as the real world event.

19. The system of claim 6, wherein the event content transmitter transmits the event content by way of the Internet for reception by the event content receptor.

20. The system of claim 6, wherein the event content transmitter transmits the event content by way of a cellular network.

21. The system of claim 6, wherein the event content transmitter transmits the event content by way of a removable recording medium for a data storage device.

22. The system of claim 21, wherein the data storage device comprises an optical storage device, and the recording medium comprises a CD or a DVD.

23. The system of claim 1, further comprising a measurable quality measurement tool and a clock time measurement tool.

24. The system of claim 23, wherein the measurable quality measurement tool is employed to obtain a first virtual measurement of a virtual world measurable quality of one or more virtual world objects over a virtual world clock time span of the simulation.

25. The system of claim 24, wherein the measurable quality measurement tool includes one or more algorithms for translating the first virtual measurement to a measurement value corresponding to the equivalent measurement of the corresponding measurable quality of the corresponding one or more real world objects over the corresponding span of clock time of the real world event.

26. The system of claim 24, wherein the first virtual measurement comprises a measurement of distance, a measurement of direction, a measurement of velocity, or a measurement of acceleration.

27. The system of claim 23, wherein the clock time measurement tool is used to obtain a second virtual measurement of a virtual world clock time.

28. The system of claim 27, wherein the clock time measurement tool includes one or more algorithms for translating the second virtual measurement to a measurement value corresponding to an equivalent measurement of the corresponding virtual world clock time of the real world event.

29. The system of claim 27, wherein the second virtual measurement comprises a measurement of a clock time, a span of clock time, or a duration of time.

30. A method for the production of presentation content depicting a real world event on one or more presentation devices, comprising the steps of:
producing event content for the real world event;
distributing the event content from the event content producer;
receiving event content from the event content distributor; and
translating the event content to presentation content by generating renderings of the simulation for display on the one or more presentation devices;
wherein step (a) is performed by an event content producer;
wherein step (b) is performed by an event content distributor;
wherein steps (c), (d) and (e) are performed by an event content translator.

31. The method of claim 30, wherein the real world event is selected from the group consisting of a sporting event, a motor sports event, a military training exercise, a policing force training exercise, a portion of the operations of one or more commercial or industrial enterprises, an artistic performance, a theater performance, and a music concert.

32. The method of claim 30, wherein the presentation content is provided for an entertainment presentation, wherein the presentation content depicts a dramatic version of the real world event.

33. The method of claim 30, wherein the event content producer comprises a telemetry reception means for receiving telemetry measurements of one or more real world objects of the real world event.

34. The method of claim 33, wherein the event content producer further comprises one or more algorithms for converting the telemetry measurements of each real world object to corresponding telemetry based virtual world values.

35. The method of claim 30, wherein the event content distributor comprises an event content transmitter for receiving event content from the event content producer and transmitting the received event content for reception by one or more event content receptors.

36. The method of claim 35, wherein the event content receptor receives event content from the event content transmitter and sends the received event content to the event content translator.

37. The method of claim 36, wherein the event content receptor is disposed at a location local to the presentation devices, wherein the presentation devices are disposed at a location remote from the event content transmitter.

38. The method of claim 30, wherein the event content translator comprises a human interface for a presentation content user to select one or more user specified depiction determination selections.

39. The method of claim 38, wherein the event content translator comprises:
means for receiving transmissions from one or more human interface devices;
one or more algorithms for the interpretation and implementation of the one or more user specified depiction determination selections;
simulation algorithms for generating a simulation of the real world event, wherein each telemetry based virtual world value from the event content is used as the corresponding telemetry based virtual world value of the simulation;
rendering algorithms for generating renderings of the simulation for one or more of the presentation devices, wherein the renderings are generated synchronous with the simulation; and
means for composing the presentation content from the renderings.

40. The method of claim 38, wherein the one or more user specified depiction determination selections comprise user control of a temporal position of the simulation, a temporal direction of the simulation, and a temporal rate of the simulation.

41. The method of claim 38, wherein each presentation device comprises a display device and a sound output device, wherein the one or more user specified depiction determination selections include user control of the virtual cinematography of the renderings generated for the display device.

42. The method of claim 41, wherein user control of the virtual cinematography comprises:
the ability to select a target from a plurality of targets within the simulation that the renderings track, wherein the plurality of targets include one or more virtual world objects;
control of the position within the simulation that the renderings are taken from;
control of the direction within the simulation that the renderings are taken from; and
the ability to select a camera style from a plurality of camera styles to use for the renderings, wherein the camera style comprises an algorithmic determination of position and direction within the simulation that the renderings are taken from.

43. The method of claim 30, wherein the event content producer produces event content including telemetry based virtual world values that are concurrent with the real world event and at a rate equal to a rate at which the telemetry measurements are made.

44. The method of claim 43, wherein the event content distributor distributes the telemetry based virtual world values concurrent with the production of the telemetry based virtual world values and at a rate equal to the rate at which the telemetry measurements are made.

45. The method of claim 43, wherein the event content producer produces the telemetry based virtual world values portion of the event content concurrent with the real world event and at a rate equal to the rate at which the telemetry measurements are made.

46. The method of claim 43, wherein the event content distributor distributes the telemetry based virtual world values before any of the telemetry based virtual world values are used for the simulation.

47. The method of claim 30, wherein the event content translator translates the event content to the presentation content concurrent with the real world event, wherein the event content translator simulates the real world event to operate at the same rate as the real world event.

48. The method of claim 35, wherein the event content transmitter transmits the event content by way of the Internet for reception by the event content receptor.

49. The method of claim 35, wherein the event content transmitter transmits the event content by way of a cellular network.

50. The method of claim 35, wherein the event content transmitter transmits the event content by way of a removable recording medium for a data storage device.

51. The method of claim 50, wherein the data storage device comprises an optical storage device, and the recording medium comprises a CD or a DVD.

52. The method of claim 30, further comprising a measurable quality measurement tool and a clock time measurement tool.

53. The method of claim 52, wherein the measurable quality measurement tool is employed to obtain a first virtual measurement of a virtual world measurable quality of one or more virtual world objects over a virtual world clock time span of the simulation.

54. The method of claim 53, wherein the measurable quality measurement tool includes one or more algorithms for translating the first virtual measurement to a measurement value corresponding to an equivalent measurement of the corresponding measurable quality of the one or more real world objects over the virtual world clock time span of the real world event.

55. The method of claim 53, wherein the first virtual measurement comprises a measurement of distance, a measurement of direction, a measurement of velocity, or a measurement of acceleration.

56. The method of claim 52, wherein the clock time measurement tool is used to obtain a second virtual measurement of a virtual world clock time.

57. The method of claim 56, wherein the clock time measurement tool includes one or more algorithms for translating the second virtual measurement to a measurement value corresponding to the equivalent measurement of the corresponding measurable quality of the corresponding one or more real world objects over the corresponding span of clock time of the real world event.

58. The method of claim 56, wherein the second virtual measurement comprises a measurement of a clock time, a span of clock time, or a duration of time.

59. A system for the production of presentation content for one or more presentation devices, wherein the presentation content depicts a real world event, the system comprising:
an event content production mechanism for the production of event content for the real world event;
an event content distribution mechanism for the distribution of the event content from the event content production mechanism; and
an event content translation mechanism for receiving the event content from the event content distribution mechanism, translating the event content to presentation content, and transmitting the presentation content to the one or more presentation devices.

60. The system of claim 59, wherein the event content production mechanism includes a telemetry reception mechanism for receiving the set of telemetry measurements of each real world object of the real world event.

61. The system of claim 59, wherein the event content production mechanism includes a first computational mechanism for operating one or more algorithms to convert the set of telemetry measurements of each real world object of the real world event to a corresponding set of telemetry based virtual world values.

62. The system of claim 59, wherein the event content distribution mechanism includes an event content transmission mechanism for receiving the event content from the event content production mechanism and transmitting the received event content to a plurality of event content reception mechanisms.

63. The system of claim 62, wherein each event content reception mechanism receives the event content from the event content transmission mechanism and sends the received event content to the event content translation mechanism.

64. The system of claim 63, wherein the event content reception mechanisms are disposed at a location local to the presentation devices, wherein the presentation devices are disposed at a location remote from the event content transmitter.

65. The system of claim 59, wherein the event content translation mechanism includes a human interface for a presentation content user to select one or more user specified depiction determination selections.

66. The system of claim 65, wherein the user specified depiction determination selections comprise:
one or more human interface devices;
a communication mechanism for receiving transmissions from the human interface devices;
a second computational mechanism for operating algorithms interpreting and implementing the one or more user specified depiction determination selections, for operating simulation algorithms calculating the simulation of the real world event using each telemetry based virtual world value from the event content for the corresponding telemetry based virtual world value of the simulation, and for operating rendering algorithms calculating renderings of the simulation synchronous with the simulation for the one or more of the presentation devices, and for composing the presentation content from the renderings; and
a presentation content transmission mechanism for transmitting the presentation content to the one or more presentation devices.

67. The system of claim 66, wherein the second computational mechanism comprises a personal computer, a video game console, or a cellular telephone.
